(19) United States
(12) Patent Application Publication
(10) Pub. No.: US 2024/0400152 A1
(43) Pub. Date: Dec. 5, 2024

(54) BEARING, METHOD OF PREPARING THE SAME AND BICYCLE COMPONENT

(71) Applicant: TIEN HSIN INDUSTRIES CO., LTD., Taichung City (TW)

(72) Inventor: WEI-CHIH WEI, Taichung City (TW)

(73) Assignee: TIEN HSIN INDUSTRIES CO., LTD., Taichung City (TW)

(21) Appl. No.: 18/359,884

(22) Filed: Jul. 27, 2023

(30) Foreign Application Priority Data
May 31, 2023 (TW) 112205472

(51) Int. Cl. B62K 21/06; B62M 9/121; F16C 19/06; F16C 33/66

(52) U.S. Cl. CPC B62K 21/06; B62M 9/121; F16C 19/06; F16C 33/6633

(57) ABSTRACT

A bearing includes a first annular member, a second annular member, and a plurality of rolling members. A receiving space is formed between the second annular member and the first annular member. The rolling members are disposed in the receiving space. The first annular member, the second annular member, and the rolling members are rotatable relative to one another. A damping grease is filled in the receiving space and is arranged between the rolling members to provide a damping force while the bearing is rotating. A viscosity of the damping grease ranges between 200 cSt and 200000 cSt.

### BACKGROUND OF THE INVENTION

### Technical Field

The present disclosure relates generally to a bearing, and more particularly to a bearing, which could enhance damping.

### Description of Related Art

It is well known that a bearing is a component supporting a rotation shaft and is adapted to bear a radial load of the rotation shaft and to reduce a friction generated due to the rotation of the rotation shaft. The bearing is widely used in different mechanical apparatus. Generally, the objective of disposing the bearing mainly is to allow components to smoothly rotate. However, in some cases, inconveniences are resulted when the components rotate relative to one another too easily.

For example, in a headset of a bicycle, a conventional bearing is disposed between a head tube and a steerer tube of a fork, so that the head tube could smoothly rotate relative to the steerer tube. However, when a handle bar is operated to drive the steerer tube to rotate, the steerer tube easily oversteers due to the bearing; or when the bicycle starts to move, the steerer tube deviates along with the handle bar. Thus, the conventional bearing still has room for improvement.

### BRIEF SUMMARY OF THE INVENTION

In view of the above, the primary objective of the present disclosure is to provide a bearing, which could enhance damping.

The present disclosure provides a bearing including a first annular member, a second annular member, and a plurality of rolling member. A receiving space is formed between the second annular member and the first annular member. The plurality of rolling members are disposed in the receiving space of the bearing. The first annular member, the second annular member, and the rolling member are rotatable relative to one another. A damping grease is filled in the receiving space of the bearing and is arranged between the rolling members to provide a damping force while the bearing is rotating. A viscosity of the damping grease ranges between 200 cSt and 200000 cSt.

In an embodiment, the viscosity of the damping grease ranges between 2000 cSt and 150000 cSt.

In an embodiment, the rolling members are balls or rollers.

In an embodiment, the bearing further comprises a retainer disposed in the receiving space of the bearing and adapted to maintain an interval between any two of the rolling members that are adjacent.

The present disclosure further provides a bicycle component including the bearing according to any one of the aforementioned embodiments.

In an embodiment, the bicycle component is a headset of a bicycle. The first annular member of the bearing is connected to a head tube of a bicycle frame, the second annular member is connected to a steerer tube of a bicycle fork, and the steerer tube passes through the head tube.

In an embodiment, the bicycle component is a rear derailleur of a bicycle. The rear derailleur includes a moving portion and a chain guide assembly connected to the moving portion. The moving portion includes a housing and a rotating assembly. The rotating assembly includes a first bearing, a pivot shaft, and a second bearing, wherein the first bearing is the bearing according to any one of the aforementioned embodiments. An end of the pivot shaft is connected to the chain guide assembly. The second bearing fits around the pivot shaft. The first bearing fits around the second bearing and has an outer abutting surface and an inner abutting surface. An inner peripheral edge of the second bearing is in contact with the pivot shaft, and an outer peripheral edge of the second bearing abuts against the inner abutting surface of the first bearing. The outer abutting surface of the first bearing abuts against an inner wall of a receiving space in the housing.

The present disclosure further provides a method of preparing a bearing, wherein the bearing includes a plurality of rolling members disposed in a receiving space between a first annular member and a second annular member of the bearing. The method of preparing the bearing includes filling the receiving space of the bearing with a damping grease.

In an embodiment, the method further comprises heating the damping grease to between 50° C. and 180° C. in advance and then filling the receiving space of the bearing with the damping grease.

In an embodiment, the method further comprises heating the damping grease to between 50° C. and 100° C. in advance and then filling the receiving space of the bearing with the damping grease.

In an embodiment, a viscosity of the damping grease ranges between 2000 cSt and 150000 cSt.

With the aforementioned design, the damping grease is filled in the receiving space of the bearing to provide the damping force while the bearing is rotating, so that when the component connected to the first annular member and another component connected to the second annular member could rotate relative to each other without simultaneously rotating in a large degree, thereby achieving the purpose of reducing the rotating speed and the rotating degree of different components.

### BRIEF DESCRIPTION OF THE SEVERAL VIEWS OF THE DRAWINGS

The present disclosure will be best understood by referring to the following detailed description of some illustrative embodiments in conjunction with the accompanying drawings, in which

FIG. 1 is a perspective view of the headset according to an embodiment of the present disclosure;

FIG. 2 is a schematic view, showing a part of the headset according to the embodiment of the present disclosure being exploded;

FIG. 3 is a side view of the headset according to the embodiment of the present disclosure;

FIG. 4 is a sectional view along the 4-4 line in FIG. 3;

FIG. 5 is a partially enlarged view of a marked region 5 in FIG. 4;

FIG. 6 is a sectional view along the 6-6 line in FIG. 3;

FIG. 7 is a perspective view of the rear derailleur according to another embodiment of the present disclosure; and

FIG. 8 is a schematic view, showing a part of the rear derailleur according to the another embodiment of the present disclosure being exploded.

### DETAILED DESCRIPTION OF THE INVENTION

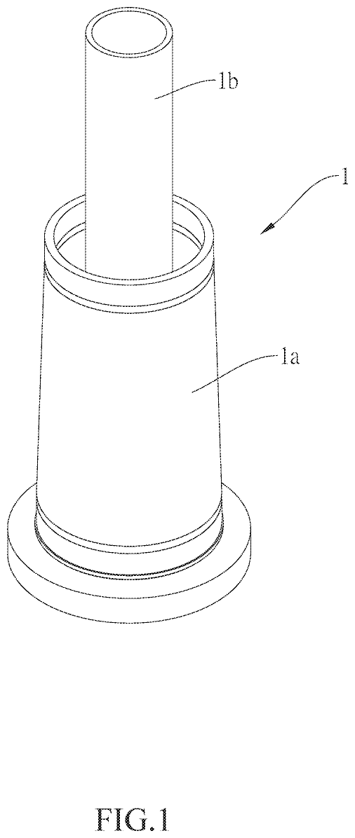

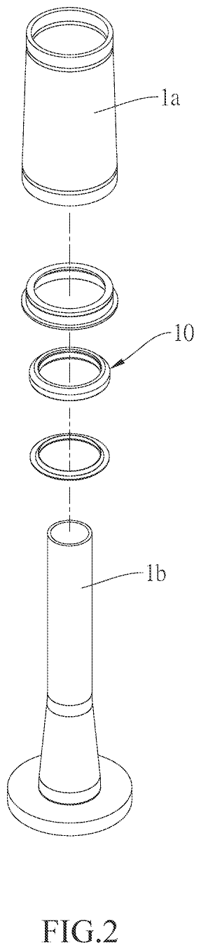

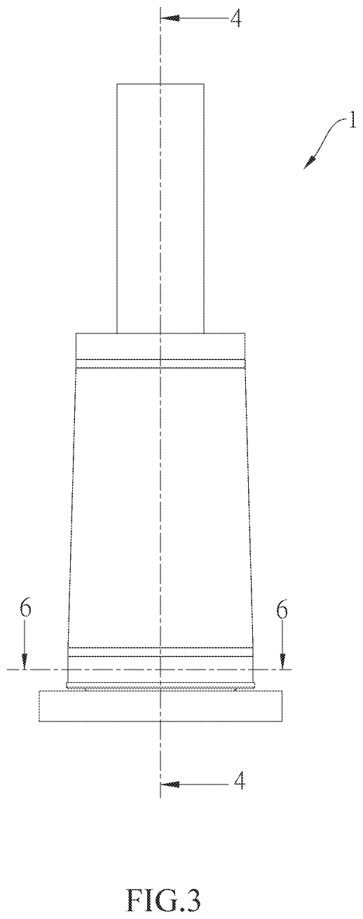

A bearing 10 according to an embodiment of the present disclosure is illustrated in FIG. 1 to FIG. 6. The bearing 10 is used in a bicycle component of a bicycle, but not limited thereto. The bicycle could be, for example, electric bike, mountain bike, cargo bike, or other bikes with uneven weight distribution on a front and a rear or with a large assistant power, but not limited thereto. In the current embodiment, the bicycle component is a headset 1 of the bicycle as an example. In other embodiments, the bearing 10 could be used in other mechanisms.

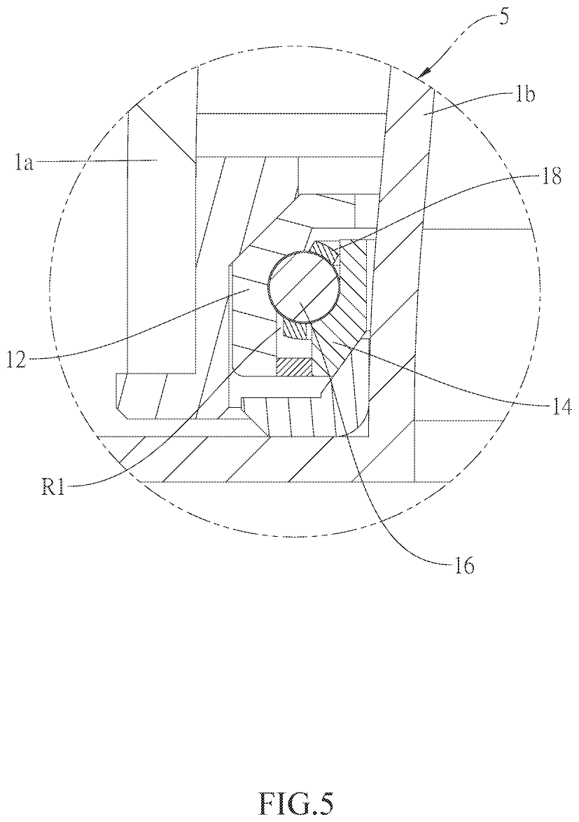

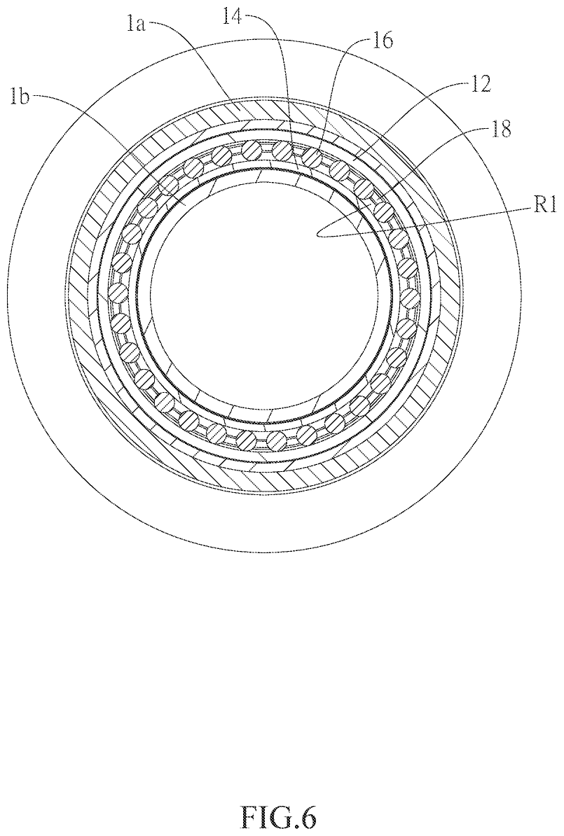

The bicycle component includes the bearing 10. As shown in FIG. 5 and FIG. 6, the bearing 10 includes a first annular member 12, a second annular member 14, a plurality of rolling members 16, and a retainer 18. A receiving space R1 is formed between the second annular member 14 and the first annular member 12. The rolling members 16 are arranged in the retainer 18 at intervals. The rolling members 16 and the retainer 18 are jointly disposed in the receiving space R1 of the bearing 10. The rolling members 16 could be balls or rollers. The first annular member 12, the second annular member 14, and the rolling members 16 are rotatable relative to one another. A damping grease is filled in the receiving space R1 of the bearing 10 and is arranged between the rolling members 16 to provide a damping force while the bearing 10 is rotating, wherein a viscosity of the damping grease ranges between 200 cSt and 200000 cSt. Preferably, the viscosity of the damping grease ranges between 2000 cSt and 150000 cSt. In this way, a component connected to the first annular member 12 and another component connected to the second annular member 14 could rotate relative to each other without simultaneously rotating in a large degree, so that the purpose of reducing a rotating speed and a rotating degree of the component connected to the first annular member 12 and the another component connected to the second annular member 14 could be achieved. The damping grease could be silicone oil as an example, but not limited thereto.

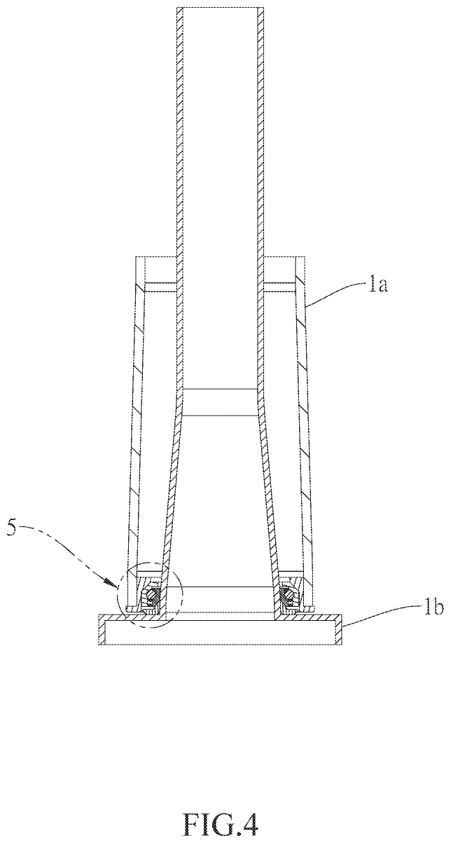

As shown in FIG. 4 and FIG. 5, the first annular member 12 is connected to a head tube 1a of a bicycle frame, the second annular member 14 is connected to a steerer tube 1b of a bicycle fork, and the steerer tube 1b passes through the head tube 1a. In this way, a speed and a degree of the relative rotation of the head tube 1a and the steerer tube 1b could be reduced, so that risks that cause a user to fall from the bicycle, such as a stem suddenly oversteering while the bicycle starts to move or the stem accidentally turning due to an excessive load on the bicycle, could be prevented.

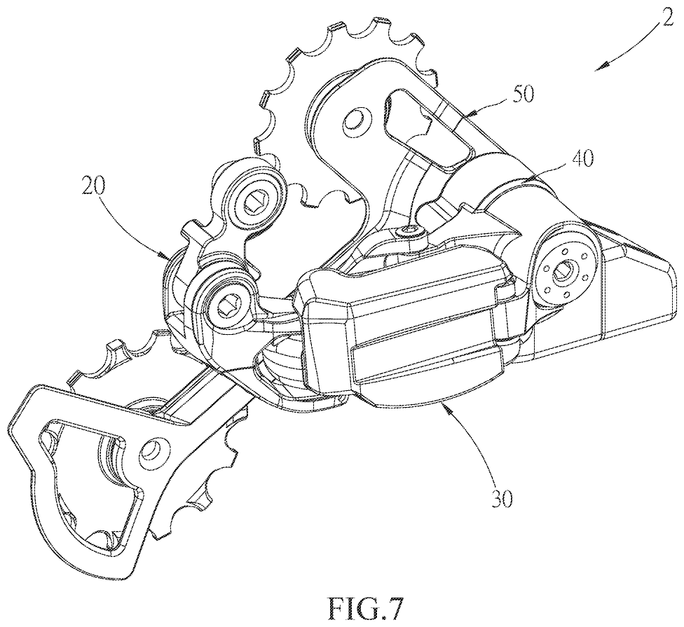

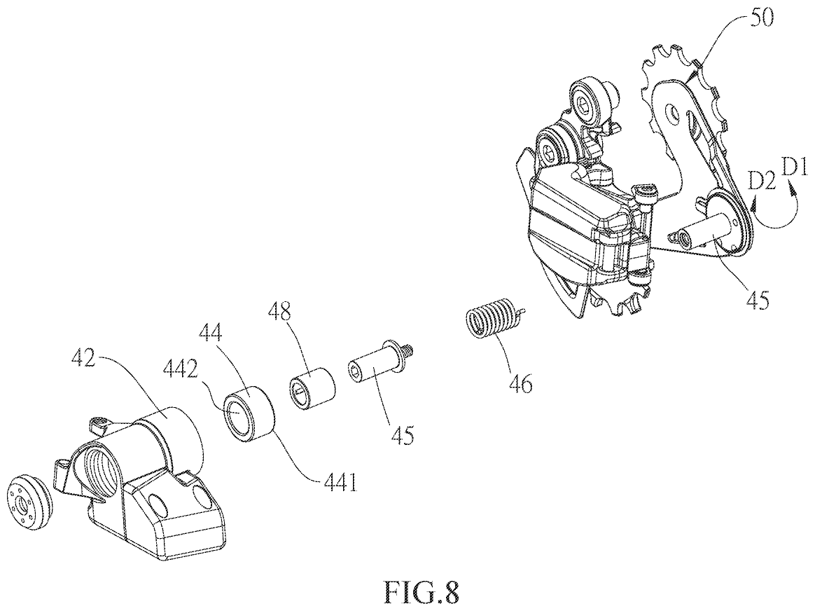

Referring to FIG. 7 and FIG. 8, in another embodiment, the bicycle component is a rear derailleur 2 including a fixing portion 20, a linkage assembly 30, a moving portion 40, a chain guide assembly 50, and a driving assembly (not shown). The fixing portion 20 is adapted to be connected to a frame of the bicycle. An end of the linkage assembly 30 is pivotally connected to the fixing portion 20. The moving portion 40 is pivotally connected to another end of the linkage assembly 30 opposite to the fixing portion 20. The chain guide assembly 50 is connected to the moving portion 40. The driving assembly drives the linkage assembly 30 to pivot, thereby driving the moving portion 40 and the chain guide assembly 50 to move. The moving portion 40 includes a housing 42 and a rotating assembly. The rotating assembly includes a first bearing 44, a pivot shaft 45, an elastic member 46, and a second bearing 48, wherein the first bearing 44 is the bearing 10 according to the embodiment of the present disclosure. An end of the pivot shaft 45 is connected to the chain guide assembly 50. The elastic member 46 fits around the pivot shaft 45, and an end of the elastic member 46 is connected to the chain guide assembly 50, thereby providing a torque along a first rotation direction D1 to the pivot shaft 45. The second bearing 48 fits around the pivot shaft 45. The first bearing 44 fits around the second bearing 48 and has an outer abutting surface 441 and an inner abutting surface 442. An inner peripheral edge of the second bearing 48 is in contact with the pivot shaft 45, and an outer peripheral edge of the second bearing 48 abuts against the inner abutting surface 442 of the first bearing 44. The outer abutting surface 441 of the first bearing 44 abuts against an inner wall of a receiving space in the housing 42.

The second bearing 48 could be a one-way bearing. When the rotating assembly rotates along the first rotation direction D1, the inner peripheral edge and the outer peripheral edge of the second bearing 48 could rotate relatively. When the rotating assembly rotates along a second rotation direction D2 opposite to the first rotation direction D1, the inner peripheral edge and the outer peripheral edge of the second bearing 48 could not rotate relatively, so that the first bearing 44 provides a predetermined friction, thereby preventing the moving portion 40 from loosening due to a vibration of the rotating assembly or an external force exerted on the moving portion 40

In this way, the first bearing 44 could provide a damping effect to reduce a swinging speed of the chain guide assembly 50, so that the chain guide assembly 50 could be prevented from shaking or vibrating excessively to cause a chain to jump, which affects an engagement between the chain and a sprocket or causes a chain drop.

The present disclosure further provides a method of preparing a bearing. The method of preparing the bearing is adapted to prepare the bearing 10 according to the embodiment of the present disclosure. The method includes filling the receiving space R1 of the bearing 10 with the damping grease. The process of filling the damping grease could be dispensing the damping grease that is in paste with the viscosity ranging between 2000 cSt and 150000 cSt between the rolling members 16, or heating the damping grease to between 50° C. and 180° C. (preferably between 50° C. and 100° C.) in advance to increase a mobility of the damping grease and then filling the receiving space R1 of the bearing 10 with the damping grease that is in fluid.

With the aforementioned design, the receiving space R1 of the bearing 10 is filled with the damping grease, thereby providing the damping force while the bearing 10 is rotating. In this way, the component connected to the first annular member 12 and the another component connected to the second annular member 14 could rotate relative to each other without simultaneously rotating in a large degree, thereby achieving the purpose of reducing the rotating speed and the rotating degree of different components.

It must be pointed out that the embodiments described above are only some preferred embodiments of the present disclosure. All equivalent structures which employ the concepts disclosed in this specification and the appended claims should fall within the scope of the present disclosure.

What is claimed is:

1. A bearing, comprising:
a first annular member;
a second annular member; wherein a receiving space is formed between the second annular member and the first annular member; and
a plurality of rolling members disposed in the receiving space of the bearing, wherein the first annular member, the second annular member, and the plurality of rolling members are rotatable relative to one another;
wherein a damping grease is filled in the receiving space of the bearing and is arranged between the plurality of rolling members to provide a damping force while the bearing is rotating; a viscosity of the damping grease ranges between 200 cSt and 200000 cSt.

2. The bearing as claimed in claim 1, wherein the viscosity of the damping grease ranges between 2000 cSt and 150000 cSt.

3. The bearing as claimed in claim 1, wherein the plurality of rolling members are balls or rollers.

4. The bearing as claimed in claim 3, further comprising a retainer disposed in the receiving space of the bearing and adapted to maintain an interval between any two of the plurality of rolling members that are adjacent.

5. A bicycle component, comprising the bearing as claimed in claim 1.

6. The bicycle component as claimed in claim 5, wherein the bicycle component is a headset of a bicycle; the first annular member of the bearing is connected to a head tube of a bicycle frame, the second annular member is connected to a steerer tube of a bicycle fork, and the steerer tube passes through the head tube.

7. The bicycle component as claimed in claim 5, wherein the bicycle component is a rear derailleur of a bicycle; the rear derailleur comprises a moving portion and a chain guide assembly connected to the moving portion; the moving portion comprises a housing and a rotating assembly; the rotating assembly comprises a first bearing, a pivot shaft, and a second bearing, wherein the first bearing is the bearing as claimed in claim 1; an end of the pivot shaft is connected to the chain guide assembly; the second bearing fits around the pivot shaft; the first bearing fits around the second bearing and has an outer abutting surface and an inner abutting surface; an inner peripheral edge of the second bearing is in contact with the pivot shaft, and an outer peripheral edge of the second bearing abuts against the inner abutting surface of the first bearing; the outer abutting surface of the first bearing abuts against an inner wall of a receiving space in the housing.

8. A method of preparing a bearing, wherein the bearing comprises a plurality of rolling members disposed in a receiving space between a first annular member and a second annular member of the bearing; the method of preparing the bearing comprises filling the receiving space of the bearing with a damping grease.

9. The method as claimed in claim 8, further comprising heating the damping grease to between 50° C. and 180° C. in advance and then filling the receiving space of the bearing with the damping grease.

10. The method as claimed in claim 9, further comprising heating the damping grease to between 50° C. and 100° C. in advance and then filling the receiving space of the bearing with the damping grease.

11. The method as claimed in claim 8, wherein a viscosity of the damping grease ranges between 2000 cSt and 150000 cSt.
